(19) United States
(12) Patent Application Publication
(10) Pub. No.: US 2026/0321757 A1
(43) Pub. Date: Oct. 15, 2026

(54) INSPECTION APPARATUS AND METHOD OF ALL-SOLID-STATE RECHARGEABLE BATTERY

(71) Applicant: SAMSUNG SDI CO., LTD., Yongin-si, Gyeonggi-do (KR)

(72) Inventors: Hyeonjeong KIM, Yongin-si, Gyeonggi-do (KR); Hongjeong KIM, Yongin-si, Gyeonggi-do (KR)

(21) Appl. No.: 18/876,294

(22) PCT Filed: Apr. 4, 2024
(86) PCT No.: PCT/KR2024/095671

§ 371 Date: Dec. 18, 2024

(30) Foreign Application Priority Data
Nov. 24, 2023 (KR) 10-2023-0166065

(51) Int. Cl. H01M 10/48; G01L 5/00; H01M 10/0525; H01M 10/44

(52) U.S. Cl. CPC H01M 10/482; G01L 5/0038; H01M 10/441; H01M 10/0525

(57) ABSTRACT

An embodiment of the present disclosure provides an inspection method for an all-solid-state rechargeable battery, including an inspection main body mounted with a plurality of all-solid-state cells in which a unit cell including a positive electrode, a negative electrode, and a solid electrolyte layer is stacked; a pressurizer installed in the inspection main body and configured to pressurize the all-solid-state cells; a pressure measurer installed in the pressurizer and configured to measure the pressure applied to the all-solid-state cells; and a quality determiner configured to determine whether an all-solid-state cell is good or bad using a pressure difference at each position of the pressure measured by the pressure measurer.

### TECHNICAL FIELD

The present disclosure relates to an inspection apparatus and an inspection method for an all-solid-state rechargeable battery.

### BACKGROUND ART

Recently, as an explosion risk of batteries using liquid electrolytes has been reported, development of all-solid-state rechargeable batteries is being conducted. An all-solid-state rechargeable battery is a battery in which all materials are made of solid, and refers to a battery that uses a solid electrolyte. These all-solid-state rechargeable batteries have the advantages of being safe because there is no risk of explosion caused by electrolyte leakage, and being easy to manufacture as thin batteries, having high energy density, and being able to be implemented in large quantities.

The above-described information disclosed in the background technology of this disclosure is only for improving understanding of the background of the present invention, and therefore may include information that does not constitute prior art.

### DISCLOSURE

### Technical Problem

Embodiments attempt to provide an inspection apparatus for an all-solid-state rechargeable battery, capable of improving a process speed by quickly determining whether an all-solid-state cell is good or bad.

However, the technical objects of the present disclosure are not limited to the objects mentioned above, and other technical objects not mentioned can be clearly understood by those skilled in the art from the description of the claims.

### Technical Solution

An embodiment of the present disclosure provides an inspection apparatus for an all-solid-state rechargeable battery, including an inspection main body mounted with a plurality of all-solid-state cells in which a unit cell including a positive electrode, a negative electrode, and a solid electrolyte layer is stacked; a pressurizer installed in the inspection main body and configured to pressurize the all-solid-state cells; a pressure measurer installed in the pressurizer and configured to measure the pressure applied to the all-solid-state cells; and a quality determiner configured to determine whether an all-solid-state cell is good or bad using a pressure difference at each position of the pressure measured by the pressure measurer.

The pressurizer may include a pressurizing member configured to pressurize the all-solid-state cells, and a pressure provider configured to provide pressure to the pressurizing member.

The pressuring member may include a pair of main pressurizing members connected to the pressure provider and positioned at an outermost portion, a plurality of sub-pressurizing members positioned between the pair of main pressurizing members and spaced apart by a predetermined interval, and a pressurizing connecting member configured to extend through the sub-pressurizing members to connect the sub-pressurizing members to each other.

The pressure measurer may be installed on the sub-pressurizing member to face opposite surfaces of the all-solid-state cell.

The pressure measurer may have an area that is greater than an area of a main surface of the all-solid-state cell.

It may further include a charging and discharging device electrically connected to the all-solid-state cells and configured to charge and discharge the all-solid-state cells.

Furthermore, an embodiment of the present disclosure provides an inspection method for an all-solid-state rechargeable battery, including mounting a plurality of all-solid-state cells each including a unit cell including a positive electrode, a negative electrode, and a solid electrolyte layer on an inspection main body; pressurizing the all-solid-state cells using a pressurizer installed in the inspection main body; measuring a pressure difference at each position of the all-solid-state cell using a pressure measurer installed in the pressurizer; and determining whether the all-solid-state cell is good or bad by using a pressure difference at each position of the all-solid-state cell.

The pressurizer may include a pressurizing member configured to pressurize the all-solid-state cells, and a pressure provider configured to provide pressure to the pressurizing member, and the pressuring member may include a pair of main pressurizing members connected to the pressure provider and positioned at an outermost portion, and a plurality of sub-pressurizing members positioned between the pair of main pressurizing members and spaced apart by a predetermined interval.

The pressure measurer may be installed in the sub-pressurizing member, and the pressure measurer may be in contact with opposite surfaces of the all-solid-state cells in the pressurizing of the all-solid-state cells.

The pressure measurer may have an area that is greater than an area of a main surface of the all-solid-state cell.

Furthermore, another embodiment of the present disclosure provides an inspection method for an all-solid-state rechargeable battery, including mounting a plurality of all-solid-state cells in which a unit cell including a positive electrode, a negative electrode, and a solid electrolyte layer is stacked on an inspection main body; pressurizing the all-solid-state cells using a pressurizer installed in the inspection main body; charging and discharging the pressurized all-solid-state cells using a charging and discharging device; measuring a pressure difference at each position of the all-solid-state cell using a pressure measurer installed in the pressurizer; and determining whether the all-solid-state cell is good or bad by using a pressure difference.

The pressurizer may include a pressurizing member configured to pressurize the all-solid-state cells, and a pressure provider configured to provide pressure to the pressurizing member, and the pressuring member may include a pair of main pressurizing members connected to the pressure provider and positioned at an outermost portion, and a plurality of sub-pressurizing members positioned between the pair of main pressurizing members and spaced apart by a predetermined interval.

The pressure measurer may be installed in the sub-pressurizing member, and the pressure measurer may be in contact with opposite surfaces of the all-solid-state cells in the pressurizing of the all-solid-state cells.

The pressure measurer may have an area that is greater than an area of a main surface of the all-solid-state cell.

In the charging and discharging of the all-solid-state cells, the charging and discharging device may be electrically connected to an electrode tab of the all-solid-state cell.

### Advantageous Effects

According to the embodiments, it may be possible to quickly and accurately determine whether an all-solid-state cell is good or bad during pressurization or initial charging and discharging without using an optical method.

That is, before the initial charge and discharge, a pressure difference at each position in the solid-state cell may be measured during the pressurization process without separately applying voltage, thereby identifying an all-solid-state cell with non-uniform pressure at each position to determine whether the all-solid-state cell is good or bad. Accordingly, a process speed may be improved.

Furthermore, during initial charging and discharging under pressure, it may be possible to identify an all-solid-state cell with non-uniform pressure at each position by measuring a pressure deviation at each position of the all-solid-state cell, to determine whether the all-solid-state cell is good or bad. Accordingly, it may be possible to pre-determine all-solid-state cells that are defective due to continuous non-uniform precipitation of lithium.

Furthermore, it may be possible to determine whether multiple all-solid-state cells are good or bad, so the process speed may be improved.

### DESCRIPTION OF THE DRAWINGS

The following drawings attached to this specification illustrate preferred embodiments of the present disclosure, and together with the detailed description of the disclosure described later, serve to further understand the technical idea of the present disclosure, and thus the present disclosure should not be construed as limited to only the matters depicted in such drawings.

FIG. 1 illustrates a cross-sectional view of an all-solid-state battery.

FIG. 2 illustrates a cross-sectional view of an all-solid-state battery including a precipitated negative electrode.

FIG. 3 illustrates a schematic top plan view showing an inspection apparatus for an all solid-state rechargeable battery according to an embodiment of the present disclosure.

FIG. 4 illustrates an enlarged view of a portion of FIG. 3.

FIG. 5 illustrates a sequential flowchart showing an inspection method for an all solid-state rechargeable battery according to an embodiment of the present disclosure.

FIG. 6 illustrates a top plan view for describing an operation of FIG. 5.

FIG. 7 illustrates a pressure deviation at each position of an all-solid-state cell and whether the all-solid-state cell is good or bad as measured by an inspection method for the all-solid-state rechargeable battery according to an embodiment for five experimental examples.

FIG. 8 illustrates a sequential flowchart showing an inspection method for an all solid-state rechargeable battery according to an embodiment of the present disclosure.

FIG. 9 illustrates a top plan view for describing an operation of FIG. 8.

FIG. 10 illustrates a pressure deviation at each position of an all-solid-state cell and whether the all-solid-state cell is good or bad as measured by an inspection method for the all-solid-state rechargeable battery according to another embodiment for five experimental examples.

### MODE FOR INVENTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In addition, unless explicitly described to the contrary, the word “comprise” and variations such as “comprises” or “comprising” will be understood to imply the inclusion of stated elements but not the exclusion of any other elements.

In the drawings, the thickness is enlarged to clearly express various layers and areas, and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, herein, “layer” includes not only a shape formed on an entire surface when observed in a plan view, but also a shape formed on some surfaces. Herein, “or” is not interpreted in an exclusive sense, and for example, “A or B” is interpreted as including A, B, A+B, etc.

### Positive Electrode For All-Solid-State Rechargeable Battery

In an embodiment, in a positive electrode for an all-solid-state rechargeable battery including a current collecting layer and a positive electrode active material layer disposed on the current collecting layer, the positive electrode active material layer provides a positive electrode for an all-solid-state rechargeable battery including at least one of a positive electrode active material, a sulfide-based solid electrolyte, a binder, or a conductive material. However, the present disclosure is not limited thereto, and the positive electrode for an all-solid-state rechargeable battery may include more or fewer components than the components described above.

In an embodiment, the positive electrode for an all-solid-state rechargeable battery is manufactured by applying a positive electrode composition containing at least one of a positive electrode active material, a sulfide-based solid electrolyte, a binder, or a conductive material to a current collecting layer, followed by drying and rolling.

### Positive Electrode Active Material

The positive electrode active material may be applied without limitation as long as it is commonly used in all-solid-state rechargeable batteries. For example, the positive electrode active material may be a compound capable of reversible intercalation and deintercalation of lithium, and may include a compound represented by any of the following chemical formulas.

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}Co_{b}X_{c}D_{α}(0.90≤a≤1.8, 0≤b≤0.5, 0≤c≤0.5, 0<α≤2);

LiₐNi_{1-b-c}Co_{b}X_{c}O_{2-α}T_{α}(0.90≤a≤1.8, 0≤b≤0.5, 0≤c≤0.05, 0<α<2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α}(0.90≤a≤1.8, 0≤b≤0.5, 0≤c≤0.05, 0<α<2);

LiₐNi_{1-b-c}Mn_{b}X_{c}O_{2-α}T_{α}(0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0≤a<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂ PO₄₃ (0≤f≤2);

Li_{(3-f)}Fe₂ PO₄₃ (0≤f≤2);

LiₐFePO₄ (0.90≤a≤1.8).

In the above formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, e.g., lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium Iron phosphate (LFP).

The positive electrode active material may include lithium nickel-based oxide represented by Formula 1 below, lithium cobalt-based oxide represented by Formula 2 below, lithium iron phosphate-based compound represented by Formula 3 below, or a combination thereof.

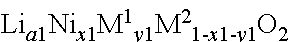

In Formula 1, 0.9≤a1≤1.8, 0.3≤x1≤1, and 0≤y1≤0.7, and M¹ and M² may each independently include one or more elements selected from Al, B, Ba, Ca, Ce, Co, Cr, Cu, F, Fe, Mg, Mn, Mo, Nb, P, S, Si, Sr, Ti, V, W, and Zr.

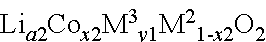

In Formula 2, 0.9≤a2≤1.8 and 0.6≤x2≤1, and M³ may include one or more elements selected from Al, B, Ba, Ca, Ce, Co, Cr, Cu, F, Fe, Mg, Mn, Mo, Nb, P, S, Si, Sr, Ti, V, W, and Zr.

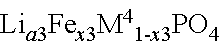

In Formula 3, 0.9≤a3≤1.8 and 0.6≤x3≤1, and M⁴ may include one or more elements selected from Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, e.g., 3 μm to 25 μm, 5 μm to 25 μm, 5 μm to 20 μm, 8 μm to 20 μm, or may be 10 μm to 18 μm. A positive electrode active material having this particle size range may be harmoniously mixed with other components within the positive electrode active material layer, and may achieve high capacity and high energy density.

The positive electrode active material may be in the form of secondary particles made by coagulating a plurality of primary particles, or may be in the form of single particles. Additionally, the positive electrode active material may be spherical or close to a spherical shape, or may be polyhedral or amorphous.

### Sulfide-Based Solid Electrolyte

Sulfide-based solid electrolytes may include, e.g., Li₂S—P₂S₅, Li₂S—P₂S₅—LiX (X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each integer and Z is Ge, Zn or Ga), Li₂S—GeS₂, Li₂S—SiS₂—Li₃PO₄, Li₂S—SiS₂-LiₚMO_{q} (p and q are integers, M is P, Si, Ge, B, Al, Ga or In), or a combination thereof.

Such sulfide-based solid electrolyte may be obtained by mixing, e.g., Li₂S and P₂S₅ at a molar ratio of 50:50 to 90:10, or 50:50 to 80:20 and optionally heat treating it. Within the above mixing ratio range, a sulfide-based solid electrolyte having excellent ionic conductivity may be manufactured. Herein, as another component, SiS₂, GeS₂, B₂S₃, etc. may be included more to further improve ionic conductivity.

Mechanical milling or solution method may be applied as a method of mixing sulfur-containing raw materials to produce a sulfide-based solid electrolyte. The mechanical milling is a method of mixing starting materials into fine particles by placing the starting materials and a ball mill in a reactor and stirring strongly. When using the solution method, solid electrolyte may be obtained as a precipitate by mixing the starting materials in a solvent. Additionally, if heat treatment is performed after mixing, the crystals of the solid electrolyte may become more solid and ionic conductivity may be improved. For example, a sulfide-based solid electrolyte may be manufactured by mixing sulfur-containing raw materials and heat treating it more than twice, and in this case, a sulfide-based solid electrolyte with high ionic conductivity and robustness may be manufactured.

For example, particles of the sulfide-based solid electrolyte may include argyrodite-type sulfide. The argyrodite-type sulfide may be represented by, e.g., a chemical formula of LiₐM_{b}P_{c}S_{d}Aₑ (a, b, c, d and e are all between 0 and 12, M is a metal other than Li or a combination of a plurality of metals other than Li, A is F, Cl, Br, or I), e.g., Li₇₋ₓPS₆₋ₓAₓ (x is 0.2 or more and 1.8 or less, and A is F, Cl, Br, or I). Specifically, the argyrodite-type sulfide may be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

Particles of the sulfide-based solid electrolyte containing such argyrodite-type sulfide may have a high ionic conductivity close to the range of 10⁻⁴ to 10⁻² S/cm, which is the ionic conductivity of a general liquid electrolyte at room temperature, may form a tight bond between the positive electrode active material and the solid electrolyte without causing a decrease in ionic conductivity, and may further form a tight interface between the electrode layer and the solid electrolyte layer. All-solid-state batteries containing this may have improved battery performance such as rate characteristics, coulombic efficiency, and lifespan characteristics.

The ajirodite-type sulfide-based solid electrolyte may be prepared, e.g., by mixing lithium sulfide, phosphorus sulfide, and optionally lithium halide. After mixing them, heat treatment may be performed. The heat treatment may include, e.g., two or more heat treatment steps.

An average particle diameter (D50) of the particles of the sulfide-based solid electrolyte according to an embodiment may be 5.0 μm or less, e.g., 0.1 μm to 5.0 μm, 0.1 μm to 4.0 μm, 0.1 μm to 3.0 μm, 0.5 μm to 2.0 μm, or may be 0.1 μm to 1.5 μm. Alternatively, the particles of the sulfide-based solid electrolyte may be small particles with an average particle diameter (D50) of 0.1 μm to 1.0 μm, or large particles with an average particle diameter (D50) of 1.5 μm to 5.0 μm, depending on a position or purpose of use. Particles of the sulfide-based solid electrolyte in this particle size range may effectively penetrate between solid particles within a battery, and may have excellent contact with electrode active materials and connectivity between solid electrolyte particles. The average particle diameter of the particles of the sulfide-based solid electrolyte may be speed of using a microscope image, and for example, it may be obtained by measuring a size of about 20 particles in a scanning electron microscope image, obtaining a particle size distribution, and calculating D50 therefrom.

A content of the solid electrolyte in a positive electrode for an all-solid-state battery may be 0.5 wt % to 35 wt %, for example, 1 wt % to 35 wt %, 5 wt % to 30 wt %, 8 wt % to 25 wt. %, or 10 wt % to 20 wt %. This is a content relative to a total weight of the components in the positive electrode, and specifically, it may be said to be a content relative to a total weight of the positive electrode active material layer.

In an embodiment, the positive electrode active material layer may include 50 wt % to 99.35 wt % of the positive electrode active material with respect to 100 wt % of the positive electrode active material layer, 0.5 wt % to 35 wt % of the sulfide-based solid electrolyte, 0.1 wt % to 10 wt % of a fluorine-based resin binder, and 0.05 wt % to 5 wt % of vanadium oxide. If this content range is satisfied, the positive electrode for an all-solid-state rechargeable battery may achieve high capacity and high ionic conductivity while maintaining high adhesion, and viscosity of the positive electrode composition may be maintained at an appropriate level, thereby improving processability.

### Binder

The binder helps the particles of the positive electrode active material adhere to each other and also serves to adhere the positive electrode active material to the current collector, representative examples of which include polymers including polyvinyl alcohol, carboxymethylcellulose, hydroxypropylcellulose, diacetylcellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene butadiene rubber, acrylated styrene butadiene rubber, epoxy resin, nylon, etc., but the present disclosure is not limited thereto.

### Conductive Material

The positive electrode active material layer may further include a conductive material. The conductive material may be used to provide conductivity to the electrode, and may include, e.g., a carbon-based material such as natural graphite, artificial graphite, carbon black, acetylene black, Ketjen black, carbon fiber, and carbon nanotubes; a metallic substance containing copper, nickel, aluminum, silver, etc. and in the form of metal powder or metal fiber; a conductive polymer such as polyphenylene derivative; or a combination thereof.

The conductive material may be included in an amount of 0.1 wt % to 5 wt %, or 0.1 wt % to 3 wt %, based on a total weight of each component of the positive electrode for an all-solid-state battery, or based on a total weight of the positive electrode active material layer. Within the above content range, the conductive material may improve electrical conductivity without deteriorating battery performance.

If the positive electrode active material layer further includes a conductive material, the positive electrode active material layer may include 45 wt % to 99.25 wt % of the positive electrode active material with respect to 100 wt % of the positive electrode active material layer, 0.5 wt % to 35 wt % of the sulfide-based solid electrolyte, 0.1 wt % to 10 wt % of a fluorine-based resin binder, 0.05 wt % to 5 wt % of vanadium oxide, and 0.1 wt % to 5 wt % of a conductive material.

Meanwhile, the positive electrode for a lithium rechargeable battery may further include an oxide-based inorganic solid electrolyte in addition to the solid electrolyte described above. The oxide-based inorganic solid electrolyte may include, e.g., Li₁₊ₓTi₂₋ₓAl(PO₄)₃(LTAP)(0≤x≤4), Li_{1+x+y}AlₓTi₂₋ₓSi_{y}P_{3-y}O₁₂(0<x<2, 0≤y<3), BaTiO₃, Pb(Zr,Ti)O₃(PZT), Pb₁₋ₓLaₓZr_{1-y}Ti_{y}O₃(PLZT)(0≤x<1, 0≤y<1), PB(Mg₃Nb_{2/3})O₃—PbTiO₃(PMN-PT), HfO₂, SrTiO₃, SnO₂, CeO₂, Na2O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂(0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M=Te, Nb, or Zr; x is an integer from 1 to 10), or a combination thereof.

### All-Solid-State Rechargeable Battery

In an embodiment, an all-solid-state rechargeable battery is provided including the positive electrode and the negative electrode described above, and a solid electrolyte layer positioned between the positive electrode and the negative electrode. The all-solid-state rechargeable battery may be expressed as an all-solid-state battery or an all-solid-state lithium rechargeable battery.

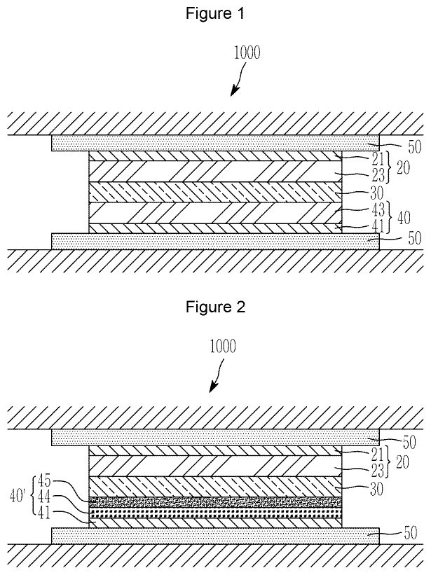

FIG. 1 illustrates a cross-sectional view of an all-solid-state battery.

Referring to FIG. 1, the all-solid-state battery 1000 may include a structure in which a negative electrode 40 including a negative current collecting layer 41 and a negative electrode active material layer 43, a solid electrolyte layer 30, and a positive electrode 20 including a positive electrode active material layer 23 and a positive current collecting layer 21 are stacked is stored in a case such as a pouch. The all-solid-state rechargeable battery 1000 may further include an elastic layer 50 outside at least one of the positive electrode 20 or the negative electrode 40. Although FIG. 1 shows one electrode assembly including the negative electrode 40, the solid electrolyte layer 30, and the positive electrode 20, an all-solid-state battery may also be manufactured by stacking two or more electrode assemblies.

### Negative Electrode

For example, a negative electrode for an all-solid-state battery may include a current collecting layer and a negative electrode active material layer positioned on the current collecting layer. The negative electrode active material layer includes a negative electrode active material, and may further include a binder, a conductive material, and/or a solid electrolyte.

The negative electrode active material may include a material capable of reversibly intercalating)/deintercalating lithium ions, lithium metal, an alloy of lithium metal, a material capable of doping and dedoping lithium, or a transition metal oxide.

The material capable of reversibly intercalating/deintercalating lithium ions may include a carbon-based negative electrode active material, e.g., crystalline carbon, amorphous carbon, or a combination thereof. Examples of the crystalline carbon may include graphite such as amorphous, plate-shaped, flake-shaped, spherical or fibrous natural graphite or artificial graphite, and examples of the amorphous carbon may include soft carbon or hard carbon, mesophase pitch carbide, and calcined coke.

As the alloy of the lithium metal, an alloy of lithium with one or more metals selected from Na, K, Rb, Cs, Fr, Be, Mg, Ca, Sr, Si, Sb, Pb, In, Zn, Ba, Ra, Ge, Al and Sn may be used.

A Si-based negative electrode active material or a Sn-based negative electrode active material may be used as a material capable of doping and dedoping lithium, the Si-based negative electrode active material may include silicon, silicon-carbon composite, SiOₓ (0<x<2), or an Si-Q alloy (The Q is an element selected from alkali metals, alkaline earth metals, Group 13 elements, Group 14 elements, Group 15 elements, Group 16 elements, transition metals, rare earth elements, and combinations thereof, but not Si), and the Sn-based negative electrode active material may include Sn, SnO₂, and an Sn—R alloy (The R is an element selected from the group consisting of alkali metals, alkaline earth metals, Group 13 elements, Group 14 elements, Group 15 elements, Group 16 elements, transition metals, rare earth elements, and combinations thereof, but not Sn), etc., and also at least one of these may be mixed with SiO₂. The element Q and the element R may each include at least one element selected from Mg, Ca, Sr, Ba, Ra, Sc, Y, Ti, Zr, Hf, Rf, V, Nb, Ta, Db, Cr, Mo, W, Sg, Pb, Pt, Cu, Ag, Au, Zn, Cd, B, Al, Ga, Sn, In, TI, Ge, P, As, Sb, Bi, S, Se, Te, Po, and a combination thereof.

For example, the silicon-carbon composite may be a silicon-carbon composite including a core containing crystalline carbon and silicon particles and an amorphous carbon coating layer positioned on a surface of the core. The crystalline carbon may be artificial graphite, natural graphite, or a combination thereof. As a precursor of the amorphous carbon, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % based on a total weight of the silicon-carbon composite. In addition, a content of the crystalline carbon may be wt % to 70 wt % based on the total weight of the silicon-carbon composite, and a content of the amorphous carbon may be 20 wt % to 40 wt % based on the total weight of the silicon-carbon composite. Additionally, a thickness of the amorphous carbon coating layer may be 5 nm to 100 nm.

The average particle diameter (D50) of the silicon particles may be 10 nm to 20 μm, e.g., 10 nm to 500 nm. The silicon particles may exist in an oxidized form, and in this case, an atomic content ratio of Si:O in the silicon particles, which indicates a degree of oxidation, may be 99:1 to 33:67. The silicon particles may be particles of SiOx, and in this case, a range of x may be greater than 0 and less than 2 in SiOx. Herein, the average particle diameter (D50) is measured with a particle size analyzer using laser diffraction and indicates a diameter of particles with a cumulative volume of 50% by volume in the particle size distribution.

The Si-based negative electrode active material or Sn-based negative electrode active material may be used by mixing with a carbon-based negative electrode active material. A mixing ratio of the Si-based negative electrode active material or Sn-based negative electrode active material; and the carbon-based negative electrode active material may be in a weight ratio of 1:99 to 90:10.

A content of the negative electrode active material in the negative electrode active material layer may be 95 wt % to 99 wt % based on a total weight of the negative electrode active material layer.

In an embodiment, the negative electrode active material layer may further include a binder, and may further include a selectively conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to ensure that particles of the negative electrode active material adhere to each other and also to adhere the negative electrode active material to the current collecting layer. The binder may include a non-water-soluble binder, a water-soluble binder, or a combination thereof.

The non-water-soluble binders may include, e.g., polyvinylchloride, carboxylated polyvinylchloride, polyvinylfluoride, polymers containing ethylene oxide, ethylene propylene copolymer, polystyrene, polyvinylpyrrolidone, polyurethane, polytetrafluoroethylene, polyvinylidene fluoride, polyethylene, polypropylene, polyamideimide, polyimide or a combination thereof.

Examples of the water-soluble binder may include a rubber binder or a polymer resin binder. The rubber-based binder may be selected from styrene-butadiene rubber, acrylated styrene-butadiene rubber, acrylonitrile-butadiene rubber, acryl rubber, butylrubber, fluorinerubber, and a combination thereof. The polymer resin binder may be selected from polyethyleneoxide, polyvinylpyrrolidone, polyphelohydrin, polyphosphazene, polyacrylonitrile, ethylenepropylenedienecopolymer, polyvinylpyridine, chlorosulfonated polyethylene, latex, polyesterresin, acrylresin, phenolresin, epoxy resin, polyvinylalcohol, and a combination thereof.

If a water-soluble binder is used as the negative binder, a thickener capable of imparting viscosity may be used together, and the thickener may include, e.g., a cellulose-based compound. The cellulose-based compound may include carboxymethyl cellulose, hydroxypropylmethyl cellulose, methyl cellulose, an alkali metal salt thereof, or a combination thereof. As the alkali metal, Na, K, or Li may be used. A content of the thickener may be 0.1 to 3 parts by weight based on 100 parts by weight of the negative electrode active material.

The conductive material may be used to provide conductivity to the electrode, and may include, e.g., a carbon-based material such as natural graphite, artificial graphite, carbon black, acetylene black, Ketjen black, carbon fiber, and carbon nanotubes; a metallic substance including copper, nickel, aluminum, silver, etc. and in the form of metal powder or metal fiber; a conductive polymer such as polyphenylene derivative; or a mixture thereof.

The negative electrode current collecting layer may be selected from copper foil, nickel foil, stainless steel foil, titanium foil, nickel foam, copper foam, a polymer substrate coated with a conductive metal, and a combination thereof.

As another example, the negative electrode for an all-solid-state battery may be a precipitated negative electrode. The precipitated negative electrode refers to a negative electrode that does not contain a negative electrode active material if the battery is assembled, but lithium metal, etc. is deposited during battery charging and this acts as a negative electrode active material.

FIG. 2 illustrates a cross-sectional view of an all-solid-state battery including a precipitated negative electrode.

Referring to FIG. 2, a precipitated negative electrode 40′ may include a current collecting layer 41 and a negative electrode coating layer 45 disposed on the current collecting layer 41. In an all-solid-state battery having such a precipitated negative electrode 40′, initial charging begins in the absence of negative electrode active material, and during charging, high-density lithium metal is precipitated between the current collecting layer 41 and the negative electrode coating layer 45 to form a lithium metal layer 44, which may serve as a negative electrode active material. Accordingly, in an all-solid-state battery that has been charged at least once, the precipitated negative electrode 40′ may include a current collecting layer 41, a lithium metal layer 44 disposed on the current collecting layer 41, and a negative electrode coating layer 45 positioned on the metal layer. The lithium metal layer 44 refers to a layer in which lithium metal, etc. is precipitated during the charging process of the battery, and may be referred to as a metal layer or a negative electrode active material layer.

The negative electrode coating layer 45 may contain a metal, a carbon material, or a combination thereof that acts as a catalyst.

The metal may include, e.g., gold, platinum, palladium, silicon, silver, aluminum, bismuth, tin, zinc, or a combination thereof, and may be formed of one of these or of several types of alloys. If the metal exists in particle form, its average particle diameter (D50) may be about 4 μm or less, e.g., 10 nm to 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, Denka black, Ketjen black, or a combination thereof.

If the negative electrode coating layer 45 includes both the metal and the carbon material, a mixing ratio of the metal and the carbon material may be, e.g., a weight ratio of 1:10 to 2:1. In this case, precipitation of lithium metal may be effectively promoted, and characteristics of the all-solid-state battery may be improved. For example, the negative electrode coating layer 45 may include a carbon material on which a catalyst metal is supported, or may include a mixture of metal particles and carbon material particles.

The negative electrode coating layer 45 may include the metal and amorphous carbon, for example, and in this case, precipitation of lithium metal can be effectively promoted.

The negative electrode coating layer 45 may further include a binder, and the binder may be a conductive binder. Additionally, the negative electrode coating layer 45 may further include general additives such as fillers, dispersants, and ion conductive agents.

A thickness of the negative electrode coating layer 45 may be, e.g., 100 nm to 20 μm, or 500 nm to 10 μm, or 1 μm to 5 μm.

For example, the precipitated negative electrode 40′ may further include a thin film on a surface of the current collecting layer 41, that is, between the current collecting layer 41 and the negative electrode coating layer 45. The thin film may contain an element that can form an alloy with lithium. The element that can form an alloy with lithium may be, e.g., gold, silver, zinc, tin, indium, silicon, aluminum, bismuth, etc., and may be formed of one type or several types of alloys. The thin film may further flatten the precipitation form of the lithium metal layer 44 and may further improve the characteristics of the all-solid-state battery. The thin film may be formed by, e.g., vacuum deposition, sputtering, or plating methods. A thickness of the thin film may be, e.g., 1 nm to 500 nm.

### Solid Electrolyte Layer

The solid electrolyte layer 30 may include a sulfide-based solid electrolyte, an oxide-based solid electrolyte, etc. Specific details of the sulfide-based solid electrolyte and the oxide-based solid electrolyte are as described above.

In an example, the solid electrolyte included in the positive electrode 20 and the solid electrolyte included in the solid electrolyte layer 30 may include a same compound or different compounds. For example, if both the positive electrode 20 and the solid electrolyte layer 30 contain an azyrodite-type sulfide-based solid electrolyte, overall performance of the all-solid-state rechargeable battery may be improved. In addition, as an example, if both the positive electrode 20 and the solid electrolyte layer 30 include the above-described coated solid electrolyte, the all-solid-state rechargeable battery may realize high capacity and high energy density while realizing excellent initial efficiency and lifespan characteristics.

Meanwhile, the average particle diameter (D50) of the solid electrolyte included in the positive electrode 20 may be smaller than the average particle diameter (D50) of the solid electrolyte included in the solid electrolyte layer 30. In this case, overall performance may be improved by maximizing energy density of the all-solid-state battery and increasing mobility of lithium ions. For example, the average particle diameter (D50) of the solid electrolyte contained in the positive electrode 20 may be 0.1 μm to 1.0 μm, or 0.1 μm to 0.8 μm, and the average particle diameter (D50) of the solid electrolyte included in the solid electrolyte layer 30 may be 1.5 μm to 5.0 μm, or 2.0 μm to 4.0 μm, or 2.5 μm to 3.5 μm. If this particle size range is satisfied, the energy density of the all-solid-state rechargeable battery may be maximized and the transfer of lithium ions may be facilitated, thereby suppressing resistance and thus improving the overall performance of the all-solid-state rechargeable battery. Herein, the average particle diameter (D50) of the solid electrolyte may be measured through a particle size analyzer using a laser diffraction method. Alternatively, the D50 may be calculated by selecting about 20 particles from a photomicroscope such as a scanning electron microscope, measuring the particle size, and obtaining the particle size distribution.

The solid electrolyte layer may further include a binder in addition to the solid electrolyte. In this case, the binder may be styrene butadiene rubber, polytetrafluoroethylene, polyvinylidene fluoride, polyethylene, acrylate polymer, or a combination thereof, but the present disclosure is not limited thereto, and anything used as a binder in the art may be used. The acrylate-based polymer may be, e.g., butyl acrylate, polyacrylate, polymethacrylate, or a combination thereof.

The solid electrolyte layer may be formed by adding a solid electrolyte to a binder solution, coating it on a base film, and drying it. A solvent for the binder solution may be isobutyl isobutyrate, xylene, toluene, benzene, hexane, or a combination thereof. Since the solid electrolyte layer forming process is widely known in the field, detailed description will be omitted.

A thickness of the solid electrolyte layer may be, e.g., 10 μm to 150 μm.

The solid electrolyte layer may further include an alkali metal salt, and/or an ionic liquid, and/or a conductive polymer.

The alkali metal salt may be, e.g., a lithium salt. A content of the lithium salt in the solid electrolyte layer may be 1M or more, e.g., 1M to 4M. In this case, the lithium salt may improve ion conductivity by improving lithium ion mobility in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂₀₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI), LiN(SO₂CF₃)₂), lithium bis(fluorosulfonyl)imide, LiFSI, LiN(SO₂F)₂), LiCF₃SO₃, LiAsF₆, LiSbF₆, LiClO₄, or a mixture thereof.

Additionally, the lithium salt may be an imide-based lithium salt, and for example, the imide-based lithium salt may include lithium bis(trifluoro methanesulfonyl)imide, LiTFSI, LiN(SO₂CF₃)₂ and lithium bis(fluorosulfonyl)imide, LiFSI, LiN(SO₂F)₂. The lithium salt may maintain or improve ionic conductivity by maintaining appropriate chemical reactivity with ionic liquid.

The ionic liquid has a melting point below room temperature, and refers to a salt that is in a liquid state at room temperature and consists of ions, or a room temperature molten salt.

The ionic liquid may be a compound containing a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof and b) one or more anions selected from BF₄—, PF₆—, AsF₆—, SbF₆—, AlCl₄—, HSO₄—, CIO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may include, e.g., one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, e.g., 10:90 to 90:10, 20:80 to 90:10, 30:70 to 90:10, 40:60 to 90:10, or 50:50 to 90:10. A solid electrolyte layer that satisfies the above range may maintain or improve ionic conductivity by improving an electrochemical contact area with the electrode. Accordingly, energy density, discharge capacity, and a rate characteristic of the all-solid-state battery may be improved.

The all-solid-state battery may be a unit battery with a structure of positive electrode/solid electrolyte layer/negative electrode, a bicell including a structure of positive electrode/solid electrolyte layer/negative electrode/solid electrolyte layer/positive electrode, or a stacked battery in which the structure of the unit cell is repeated.

A shape of the all-solid-state battery is not particularly limited, and may be, e.g., coin-shaped, button-shaped, sheet-shaped, stacked-type, cylindrical-shaped, flat-shaped, etc. Additionally, the all-solid-state battery may also be applied to large batteries used in electric vehicles, etc. For example, the all-solid-state battery may also be used in hybrid vehicles such as plug-in hybrid electric vehicles (PHEV). In addition, it may be used in fields that require large amounts of power storage, e.g., electric bicycles or power tools.

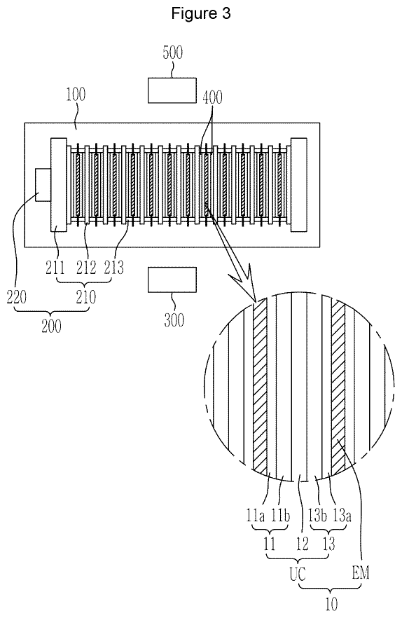

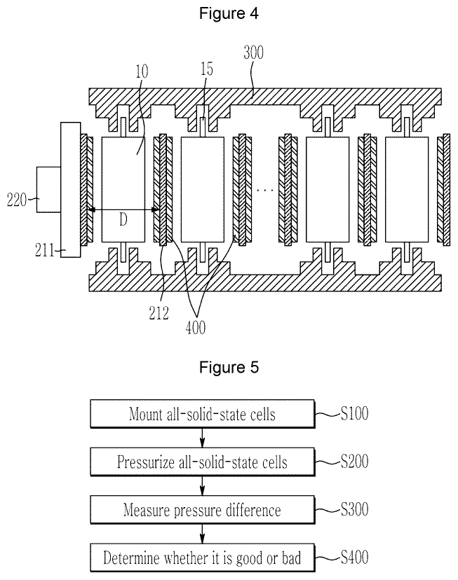

Hereinafter, an inspection apparatus for an all-solid-state rechargeable battery according to an embodiment of the present disclosure will be described with reference to FIG. 3 and FIG. 4.

The inspection apparatus for an all-solid-state rechargeable battery according to an embodiment of the present disclosure may be utilized in a manufacturing process of the all-solid-state rechargeable battery, utilized for evaluating the manufactured all-solid-state rechargeable battery, or utilized as a pressurizing means when using the all-solid-state rechargeable battery.

FIG. 3 illustrates a schematic top plan view showing an inspection apparatus for an all solid-state rechargeable battery according to an embodiment of the present disclosure, and FIG. 4 illustrates an enlarged view of a portion of FIG. 3.

As shown in FIGS. 3 and 4, the inspection apparatus for an all-solid-state rechargeable battery according to an embodiment may include an inspection main body 100, a pressurizer 200, a charging and discharging device 300, a pressure measurer 400, and a quality determiner 500.

The inspection main body 100 may include a plurality of all-solid-state cells 10. Herein, the all-solid-state cells 10 may have a stack cell structure in which a plurality of unit cells UC and elastic members EM are stacked. One unit cell UC may include a positive electrode 11, a negative electrode 13, and a solid electrolyte layer 12. Herein, the positive electrode 11 may include a cathode, and the negative electrode 13 may include an anode. The positive electrode 11 may include a positive electrode current collecting layer 11a and a positive electrode active material layer 11b positioned on a first surface of the positive electrode current collecting layer 11a. The negative electrode 13 may include a negative electrode current collecting layer 13a, and a negative electrode coating layer 13b positioned on a first surface of the negative electrode current collecting layer 13a. The solid electrolyte layer 12 may be positioned between the positive electrode active material layer 11b and the negative electrode coating layer 13b. The all-solid-state cells 10 may have an electrode tab 15 that can be electrically connected to a charging and discharging device 300.

The pressurizer 200 may pressurize opposite sides of the all-solid-state cells 10.

The pressurizer 200 may include a pressurizing member 210 and a pressure provider 220.

The pressurizing member 210 may pressurize the all-solid-state cells 10. The pressurizing member 210 may include a pair of main pressurizing members 211 positioned at an outermost end and connected to the pressure provider 220, a plurality of sub-pressurizing members 212 positioned between the pair of main pressurizing members 211 and spaced apart by a predetermined interval, and a pressurizing connecting member 213 connected to the pair of main pressurizing members 211 by extending through the sub-pressurizing members 212. The all-solid-state cells 10 may be positioned between adjacent sub-pressuring members 212.

The pressure provider 220 may provide pressure to the pressurizing member 210 to apply pressure to opposite sides of the all-solid-state cells 10. The pressure provider 220 may include a driving motor, etc. The pressure provider 220 may apply a pressure of 2 MPa to 3 MPa to opposite sides of the all-solid-state cells 10. As a distance between the pair of main pressurizing members 211 is reduced by the pressure provided by the pressure provider 220, a distance D between adjacent sub-pressurizing members 212 may be reduced, thereby pressurizing opposite sides of the all-solid-state cells 10. In this case, the sub-pressure members 212 may move along the pressure connecting member 213, and may reduce the distance D between adjacent sub-pressure members 212.

The charging and discharging device 300 may be electrically connected to the all-solid-state cells 10, and may charge and discharge the all-solid-state cells 10.

The pressure measurer 400 may be installed in the pressurizing member 210 of the pressurizer 200, and may measure the pressure applied to the all-solid-state cells 10 in real time. The pressure measurer 400 may be installed on the sub-pressuring member 212 of the pressuring member 210, and may face opposite sides of the all-solid-state cells 10. Using the pressure measured by the pressure measurer 400, a pressure deviation according to a position of the pressure applied to the all-solid-state cells 10 may be measured in real time.

This pressure measurer 400 may have an area greater than an area of a main surface, which has a widest area in the all-solid-state cell 10. Accordingly, the pressure measurer 400 may measure a pressure difference for each position of the pressure applied to all areas of the main surface of the all-solid-state cell 10. This pressure measurer 400 may be formed to include a plurality of pressure sensors formed on a flat plate, etc.

The quality determiner 500 may be connected to the pressure measurer 400. A pressure deviation at each position of the pressure measured by the pressure measurer 400 may be used to determine whether the all-solid-state cell 10 is good or bad. That is, if the pressure deviation at each position of the all-solid-state cell 10 is greater than a reference value, it may be determined as defective.

Hereinafter, an inspection method using the inspection apparatus for an all-solid-state rechargeable battery according to the above embodiment will be described in detail with reference to the drawings.

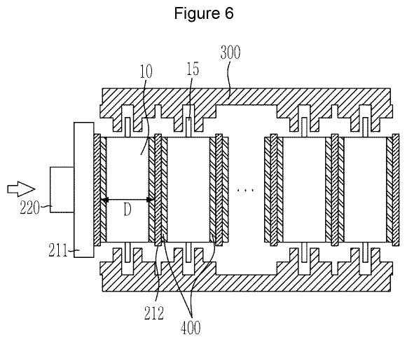

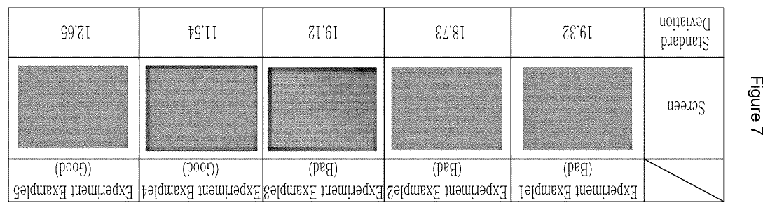

FIG. 5 illustrates a sequential flowchart showing an inspection method for an all solid-state rechargeable battery according to an embodiment of the present disclosure, and FIG. 6 illustrates a top plan view for describing an operation of FIG. 5.

As shown in FIGS. 3 to 5, first, the all-solid-state cells 10 may be mounted on the inspection main body 100 (S100). In this case, the all-solid-state cells 10 may be aligned and mounted between the sub-pressurizing members 212 of the pressurizing member or between the main pressurizing member 211 and the sub-pressurizing member 212. Herein, the all-solid-state cells 10 may be a final product having a stack cell structure in which a plurality of unit cells UC and elastic members EM are stacked.

Next, as shown in FIGS. 5 and 6, the all-solid-state cells 10 may be pressurized using a pressurizer installed in the inspection main body (S200). That is, as a distance between the pair of main pressurizing members 211 is reduced by the pressure provided by the pressure provider 220, a distance D between adjacent sub-pressurizing members 212 may be reduced, thereby pressurizing opposite sides of the all-solid-state cells 10. In this case, the pressure measurer 400 may be in contact with opposite sides of the all-solid-state cell 10, and a pressure of 2 MPa to 3 MPa may be constantly applied to the opposite sides of the all-solid-state cell 10.

Next, after a predetermined period of time, e.g., about 2 minutes, a pressure difference at each position of the all-solid-state cell 10 may be measured in real time using the pressure measurer 400 installed in the sub-pressure member 212 (S300). In this case, the charging and discharging device 300 may not be electrically connected to the electrode tab 15 of the all-solid-state cell 10.

Next, the quality determiner 500 connected to the pressure measurer 400 may determine whether the all-solid-state cell 10 is good or bad using the pressure deviation at each position of the solid-state cell 10 measured by the pressure measurer 400 (S400). In this case, if the pressure deviation at each position of the all-solid-state cell 10 is greater than a reference value, it may be determined as defective. Herein, a pressure deviation may occur at each position of the solid-state cell 10 due to reasons such as non-uniform thickness or low alignment of the positive electrode 11, the negative electrode 13, the solid electrolyte layer 12, and the elastic member EM formed inside the all-solid-state cell 10, so as to determine a defective all-solid-state cell 10.

FIG. 7 illustrates a pressure deviation at each position of an all-solid-state cell and whether the all-solid-state cell is good or bad as measured by an inspection method for the all-solid-state rechargeable battery according to an embodiment for five experimental examples. Herein, the reference value for the pressure deviation by position was set to 18.

As shown in FIG. 7, according to Experimental Examples 1 to 3, the pressure deviation by position exceeds the reference value of 18, so it is determined as a defective product, and according to Experimental Examples 4 and 5, the pressure deviation by position is less than the reference value of 18, it is determined as a good product.

In this way, the inspection method for the all-solid-state rechargeable battery according to an embodiment may determine whether it is good or bad by measuring the pressure deviation of each all-solid-state cell 10 at each position in the pressurizing process and identifying the all-solid-state cell 10 with non-uniform pressure at each position, before conducting the charging and discharging inspection. Accordingly, a process speed may be improved.

Furthermore, the all-solid-state cell 10 determined to be defective may not need to undergo the charging and discharging inspection separately, a process speed may be improved.

Meanwhile, in the present embodiment, the quality of the all-solid-state cell was determined before conducting the charging and discharging inspection, but another embodiment may also be possible in which the quality of the all-solid-state cell is determined while conducting the charging and discharging inspection under pressure.

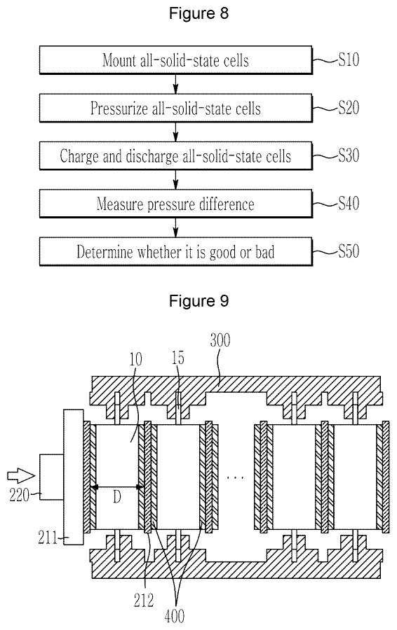

Hereinafter, an inspection apparatus for an all-solid-state rechargeable battery according to another embodiment of the present disclosure will be described with reference to FIG. 8 to FIG. 10.

FIG. 8 illustrates a sequential flowchart showing an inspection method for an all solid-state rechargeable battery according to an embodiment of the present disclosure, and

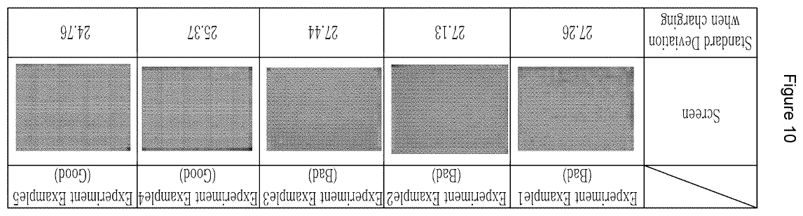

FIG. 9 illustrates a top plan view for describing an operation of FIG. 8.

The another embodiment illustrated in FIGS. 8 and 9 is substantially the same as the embodiment illustrated in FIGS. 5 and 6 except that the charging and discharging inspection is performed under pressure and the quality of the all-solid-state cell is determined, so a repeated description will be omitted.

As illustrated in FIG. 8, an inspection method for an all-solid-state rechargeable battery according to another embodiment of the present disclosure may first mount a plurality of all-solid-state cells 10 on the inspection main body 100 (S10).

Next, the all-solid-state cells 10 may be pressurized using the pressurizer 200 installed in the inspection main body 100 (S20).

Next, the all-solid-state cells 10 may be charged and discharged under pressure (S30). In this case, the charging and discharging device 300 may not be electrically connected to the electrode tab 15 of the all-solid-state cell 10.

Next, after a predetermined period of time, e.g., about 2 minutes, a pressure difference at each position of the all-solid-state cell 10 may be measured in real time using the pressure measurer 400 installed in the sub-pressure member 212 (S40). During charging and discharging of the all-solid-state cell 10, lithium may be non-uniformly precipitated in the case of a defective all-solid-state cell 10, so residual lithium may occur in some areas, which may cause a pressure difference depending on a position of the all-solid-state cell 10.

Next, the quality determiner 500 connected to the pressure measurer 400 may determine whether the all-solid-state cell 10 is good or bad using the pressure deviation at each position of the solid-state cell 10 measured by the pressure measurer 400 (S50). In this case, if the pressure deviation at each position of the all-solid-state cell 10 is greater than a reference value, it may be determined as defective.

FIG. 10 illustrates a pressure deviation at each position of an all-solid-state cell and whether the all-solid-state cell is good or bad as measured by an inspection method for the all-solid-state rechargeable battery according to another embodiment for five experimental examples. Herein, the reference value for the pressure deviation by position was set to 26.

As shown in FIG. 10, according to Experimental Examples 1 to 3, the pressure deviation by position exceeds the reference value of 26, so it is determined as a defective product, and according to Experimental Examples 4 and 5, the pressure deviation by position is less than the reference value of 26, it is determined as a good product.

In this way, the inspection method for the all-solid-state rechargeable battery according to an embodiment may determine whether it is good or bad by measuring the pressure deviation of each all-solid-state cell 10 at each position in the pressurizing process and identifying the all-solid-state cell 10 with non-uniform pressure at each position, while initially charging and discharging during pressurization. Accordingly, it may be possible to determine in advance that an all-solid-state cell 10 that is not initially determined to be defective, but later becomes defective due to non-uniform deposition of lithium that continuously occurs through charging and discharging.

While this disclosure has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. An inspection apparatus for an all-solid-state rechargeable battery, the apparatus comprising:
an inspection main body mounted with a plurality of all-solid-state cells in which a unit cell including a positive electrode, a negative electrode, and a solid electrolyte layer is stacked;
a pressurizer installed in the inspection main body and configured to pressurize the all-solid-state cells;
a pressure measurer installed in the pressurizer and configured to measure the pressure applied to the all-solid-state cells; and
a quality determiner configured to determine whether an all-solid-state cell is good or bad using a pressure difference at each position of the pressure measured by the pressure measurer.

2. The inspection apparatus of claim 1, wherein
the pressurizer includes
a pressurizing member configured to pressurize the all-solid-state cells, and a pressure provider configured to provide pressure to the pressurizing member.

3. The inspection apparatus of claim 2, wherein
the pressuring member includes
a pair of main pressurizing members connected to the pressure provider and positioned at an outermost portion,
a plurality of sub-pressurizing members positioned between the pair of main pressurizing members and spaced apart by a predetermined interval, and
a pressurizing connecting member configured to extend through the sub-pressurizing members to connect the sub-pressurizing members to each other.

4. The inspection apparatus of claim 3, wherein
the pressure measurer is installed on the sub-pressurizing member to face opposite surfaces of the all-solid-state cell.

5. The inspection apparatus of claim 3, wherein
the pressure measurer has an area that is greater than an area of a main surface of the all-solid-state cell.

6. The inspection apparatus of claim 1, further comprising
a charging and discharging device electrically connected to the all-solid-state cells and configured to charge and discharge the all-solid-state cells.

7. An inspection method for an all-solid-state rechargeable battery, the method comprising:
mounting a plurality of all-solid-state cells each including a unit cell including a positive electrode, a negative electrode, and a solid electrolyte layer on an inspection main body;
pressurizing the all-solid-state cells using a pressurizer installed in the inspection main body;
measuring a pressure difference at each position of the all-solid-state cell using a pressure measurer installed in the pressurizer; and
determining whether the all-solid-state cell is good or bad by using a pressure difference at each position of the all-solid-state cell.

8. The inspection method of claim 7, wherein
the pressurizer includes
a pressurizing member configured to pressurize the all-solid-state cells, and a pressure provider configured to provide pressure to the pressurizing member. the pressuring member includes
a pair of main pressurizing members connected to the pressure provider and positioned at an outermost portion, and
a plurality of sub-pressurizing members positioned between the pair of main pressurizing members and spaced apart by a predetermined interval.

9. The inspection method of claim 7, wherein
the pressure measurer is installed in the sub-pressurizing member, and
the pressure measurer is in contact with opposite surfaces of the all-solid-state cells in the pressurizing of the all-solid-state cells.

10. The inspection method of claim 8, wherein
the pressure measurer has an area that is greater than an area of a main surface of the all-solid-state cell.

11. An inspection method for an all-solid-state rechargeable battery, the method comprising:
mounting a plurality of all-solid-state cells in which a unit cell including a positive electrode, a negative electrode, and a solid electrolyte layer is stacked on an inspection main body;
pressurizing the all-solid-state cells using a pressurizer installed in the inspection main body;
charging and discharging the pressurized all-solid-state cells using a charging and discharging device;
measuring a pressure difference at each position of the all-solid-state cell using a pressure measurer installed in the pressurizer; and
determining whether the all-solid-state cell is good or bad by using a pressure difference.

12. The inspection method of claim 11, wherein
the pressurizer includes a pressurizing member configured to pressurize the all-solid-state cells, and a pressure provider configured to provide pressure to the pressurizing member, and
the pressuring member includes
a pair of main pressurizing members connected to the pressure provider and positioned at an outermost portion, and
a plurality of sub-pressurizing members positioned between the pair of main pressurizing members and spaced apart by a predetermined interval.

13. The inspection method of claim 12, wherein
the pressure measurer is installed in the sub-pressurizing member, and
the pressure measurer is in contact with opposite surfaces of the all-solid-state cells in the pressurizing of the all-solid-state cells.

14. The inspection method of claim 12, wherein
the pressure measurer has an area that is greater than an area of a main surface of the all-solid-state cell.

15. The inspection method of claim 12, wherein
in the charging and discharging of the all-solid-state cells,
the charging and discharging device is electrically connected to an electrode tab of the all-solid-state cell.
